(19) United States
(12) Patent Application Publication
(10) Pub. No.: US 2008/0075538 A1
(43) Pub. Date: Mar. 27, 2008

(54) Method and apparatus for repairing underground pipes

(76) Inventor: Robert F. Crane, Oconomowoc, WI (US)

Correspondence Address: Philip G. Meyers;Philip G. Meyers Law Office, Suite 300, 1009 Long Prairie Road, Flower Mound, TX, 75022, US

(21) Appl. No.: 11/528,143

(22) Filed: Sep. 27, 2006

(51) Int. Cl. F16L 55/18

(52) U.S. Cl. 405/184.3

(57) ABSTRACT

An apparatus for repairing an underground pipe includes a mandrel having a first expander capable of extending and retracting in a radial direction, a system for causing radial expansion and retraction of the expander when in position at a pipe location in need of repair, a resilient stiffening frame disposable in a tubular configuration outside of the expander, such that the expander can be used to expand the frame into contact with the inside of the pipe, and a suitable arrangement for confining a flowable cement between the expander and the inside of the pipe to form a repair band upon setting of the cement. In a preferred form of the invention, the expander comprises a central inflatable bladder, and the system controlling radial extension and retraction of the expander includes a line supplying pressurized air to the bladder.

### TECHNICAL FIELD

The invention relates to the repair of underground pipes and in particular to the repair of culverts and similar pipes with a repair band installed in the pipe.

### BACKGROUND OF THE INVENTION

Concrete pipe is used in a wide variety of applications including sanitary and storm sewers. Concrete pipe is widely used for culverts that drain, and providing drainage though, roadbeds and similar structures. Typically, concrete pipe is installed in pre-cast sections with bell-shaped end connections in which an end of a first section fits into the bell-shaped end of the next section. A gasket or packing is used to seal the connection.

Concrete pipes are susceptible to failure and leakage due to a variety of factors. The need to repair concrete pipes used in various applications has grown steadily with the aging of existing infrastructures. For example, it has been estimated that when roadbed culverts are cleaned, about 60% of the culverts have separated and/or displaced joints. Poor or under design, improper installation, heaving due to frost, settling, earthquakes and other earth movement can cause cracking, erosion and joint separation. Chemical attack on concrete pipes used as sanitary sewers is also well known.

A crack or separated joint in a concrete pipe can cause leakage into and out of the pipe. When fluid leaks into the pipe, often spoil is carried into the pipe, decreasing the flow through the pipe and creating a void in the soil or ballast supporting the pipe. When fluid leaks out of a concrete pipe, it tends to loosen or erode the soil or ballast around the pipe, potentially allowing the pipe to settle or, at the least, increasing the stress on the pipe. In either case, if enough of the soil or ballast supporting the pipe is washed away, the pipe and overlying structures may collapse. When the concrete pipe is a culvert through a road bed under a highway or railroad, such a collapse can have serious or catastrophic consequences.

Techniques for in place repair and rehabilitation underground pipes and in particular underground concrete pipes have become well known and widely used due to the inherent disadvantages of excavating such pipes. See, e.g., U.S. Pat. Nos. 7,018,691, 6,796,334 and 5,388,929. The cost of labor and machinery required for excavation has risen steadily over the years. Excavating a culvert that goes through a roadbed requires closing the road or railroad and diverting traffic, an often costly and time consuming process. Once the pipe has been excavated and replaced, the trench roadbed must be backfilled and the road repaired. Often, settlement occurs after the repair, requiring more repairs to the road and roadbed. In urban areas, excavating pipes running under streets to effect repairs can cause severe traffic disruptions.

In the case of culverts and similar concrete pipes that are large enough for personnel to physically enter, typically more than 36 inches in diameter, joint separations and similar damage may be repaired with steel repair bands. Repairing small diameter culverts without excavation is more difficult. As used herein, the term “small diameter” refers to pipes 36 inches or less in inner diameter. Generally, it is not possible for personnel to physically enter small diameter pipes to install repair bands. Other methods of repair, such as spraying a concrete mixture over the damaged area may not be satisfactory since the cured concrete has relatively little tensile strength and is vulnerable to the same type of forces that caused the original damage. This is particularly the case where the pipe or culvert must withstand significant static and live loading as in the case of a culvert under a railroad or highway roadbed.

Lining or re-lining pipes can be carried out by a number of methods for the purpose of pipeline rehabilitation. According to the commercially available “Easy-Liner” process, resin-impregnated sleeves are cured in place after being expanded into position by an inflatable bladder; see e.g. http://www.easy-liner.com/ under “Remote Liner”. According to another method described at www.relineamerica.com, a deflated liner is pulled into the pipeline to be relined, inflated with air, and then cured with UV light to form a hardened lining. See EP1262708 (A1) describing a method for repairing and regenerating a duct by installing a liner having a thick wall in the duct. The method for repairing and regenerating the duct comprises the steps of filling a fiber hose having a wall thickness of 10 mm or more and impregnated with a resin in a damaged part of the duct, mounting the hose on an inner surface of the duct, and then curing the resin. The resin contains an UV initiator and an organic peroxide. The resin is cured by a light source having at least two UV lamps each having at least 400 W output and disposed before and after the resin. A luminosity of the UV light irradiated to the inner wall of the hole needs at least 800 W/m. These and other methods of in-situ relining wherein a fabric liner is everted into the pipe and impregnated with a resin have been used commercially but may not provide sufficient tensile strength to the repaired area to withstand significant stress.

### SUMMARY OF THE INVENTION

An apparatus for repairing an underground pipe according to the invention includes a mandrel having a first expander capable of extending and retracting in a radial direction, suitable means for causing radial expansion and retraction of the expander when in position at a pipe location in need of repair, a resilient stiffening frame disposable in a tubular configuration outside of the expander, such that the expander can be used to expand the frame towards the inside of the pipe, and suitable means for confining a flowable cement between the expander and the inside of the pipe to form a repair band upon setting of the cement. The stiffening frame is preferably pervious to the cement and has a spacing element that defines a minimum thickness of the repair band. In a preferred form of the invention, the expander comprises a central inflatable bladder, and the means for controlling radial extension and retraction of the expander includes a line supplying pressurized air to the bladder.

The means for confining flowable cement between the expander and the inside of the pipe can vary considerably as described below. The site needing repair often is a break in the pipeline, and as such injection of flowable cement without anything to confine it (acting as a mold) would cause it to ooze out of the pipeline into the surrounding soil. Approaches to confining the cement generally include either providing a full or partial covering for the cement that it cannot flow through, or using seals such as air filled bladders to temporarily creating a confined space that fills up with cement as it is cast at the site to be repaired, or a combination of these. These and other examples are discussed in detail below.

A method for repairing an underground pipe according to the invention, such as by using an apparatus as described above, includes the steps of positioning a flexible stiffening frame inside the pipe at a location to be repaired, positioning an extendable expander inside of the frame, extending the expander to push the frame radially outwardly towards the inside of the pipe, injecting a flowable cement into a space between the expander and the inside of the pipe, and confining the cement so that it forms a repair band having the frame embedded therein upon curing. If the cement takes a significant amount of time to cure, the method can further include steps of maintaining the expander extended until the cement cures sufficiently to be self-supporting, then retracting the expander. Such a method can be carried out without sending a worker into the pipe or conduit, and is especially well adapted for smaller pipes or conduits less than 3 feet in inner diameter.

The expander may be mounted on a mandrel such that the positioning steps comprise wrapping the stiffening frame around the mandrel and expander, and inserting the mandrel and expander into the pipe and moving it to the location to be repaired. The stiffening frame is preferably coiled or folded around the expander and mandrel into a tubular configuration. As will become clear from the detailed description that follows, these steps are not always performed in the order listed. For example, the stiffening frame could be pre-positioned in the conduit and the apparatus then inserted into it, or could be mounted on the spacer and the apparatus and band inserted into the conduit together.

A conduit joint according to the invention, which may be formed by the foregoing method, includes a first pipe section, a second pipe section adjacent the first section, and a repair band disposed inside and spanning the first and second pipeline sections. The repair band comprises a resilient frame embedded in a hardened cement. The band is not a liner, i.e., it has a length less than that of the pipeline sections, whereby one end of the repair band opens onto the interior of the first conduit section, and the other end of the repair band opens onto the interior of the second pipeline section. Often, due to shifting of the ground, the pipe sections will have pulled apart from one another and will no longer be coaxial. In such a case, the repair band contacts and conforms to the inner surfaces of the first and second pipeline sections, effectively sealing the break.

In another aspect, the invention provides a flexible repair band for effecting repairs to an underground pipe. Such a band comprises a resilient frame as described above bendable into a coiled configuration and disposed inside of a sleeve of a fabric impervious to the cement. One or more openings are made in the sleeve prior to use so that the cement may be pumped inside to fill the sleeve. These and other aspects of the invention are further described in the detailed description that follows.

### BRIEF DESCRIPTION OF THE DRAWINGS

The invention will hereafter be described with reference to the accompanying drawings, wherein like numerals denote like elements, and wherein:

FIG. 1 is a lengthwise sectional view of an inflatable pipe repair apparatus according to the invention in a conduit prior to full inflation of the bladders;

FIG. 2 is the same view as FIG. 1, with bladders fully inflated;

FIG. 3 is the same view as FIG. 2, with bladders partially deflated following installation of a repair band according to the invention;

FIG. 4 an end view of the apparatus of FIG. 1;

FIG. 5 is a schematic end view of a folded repair band according to the invention;

FIG. 6 is a partial bottom view of a reinforcing frame according to the invention;

FIG. 7 is a side view of the frame of FIG. 6;

FIG. 8 is a end view of the frame of FIG. 6; and

FIG. 9 is a lengthwise section of a completed repair band according to the invention.

### DETAILED DESCRIPTION

According to a first example of the invention, an underground pipeline or conduit is repaired by means of a repair band that is formed from a curable cement material reinforced with a resilient metal frame. The apparatus for positioning the repair band is mounted on the end of a drill string and extended into the pipe using a horizontal directional drill (HDD) machine such as a D24x40 Navigator produced by Vermeer Manufacturing of Pella Iowa. When the apparatus is positioned at the location to be repaired, the expander is extended to expand the frame into conformity with the inside of the conduit. Grout is pumped to the area to be repaired and is retained about the frame until cured. The frame becomes embedded in the cured grout, reinforcing the repaired area.

In a preferred form of the method, the step of positioning the resilient frame precedes the introduction of the grout into contact with the frame, giving the method of the invention a cast-in-place character. For purposes of the present invention, “grout” or “cement” refer to a fluid, flowable substance that is capable of assuming a solid state following curing, setting or cooling. Conventional Portland cements can be used, but commercially available rapid-curing cements or “jet cements” are particularly preferred, since the apparatus cannot be removed until the cast repair band is sufficiently self-supporting. Plastic thermosets, epoxys and thermoplastics can also be used.

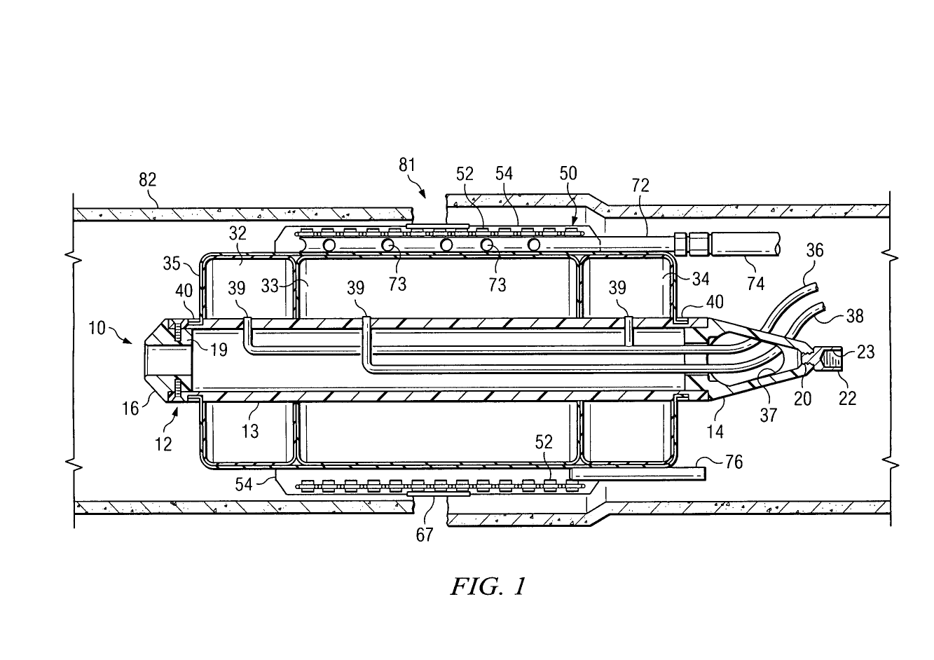

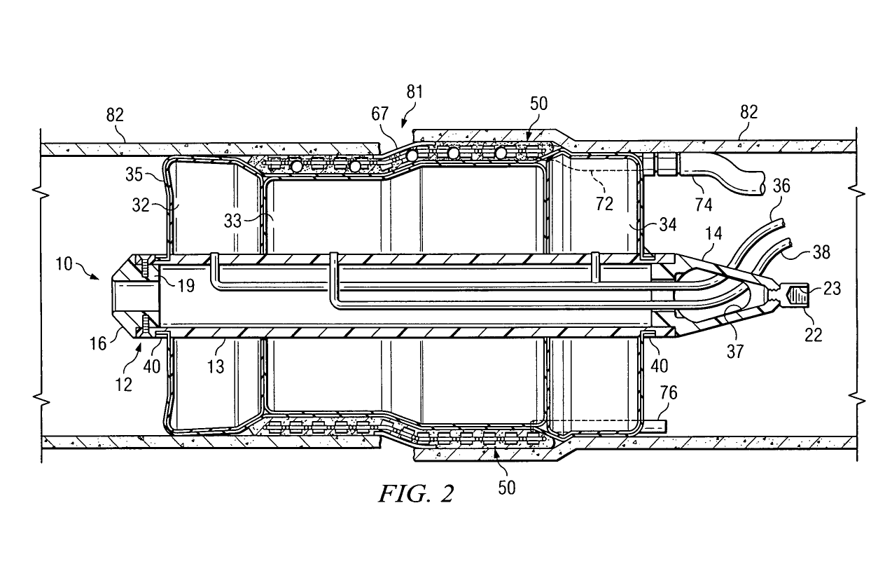

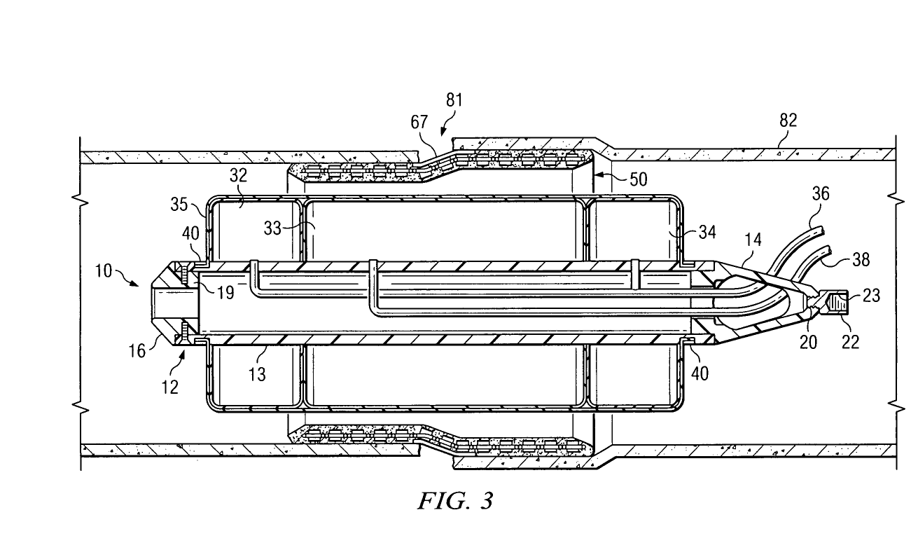

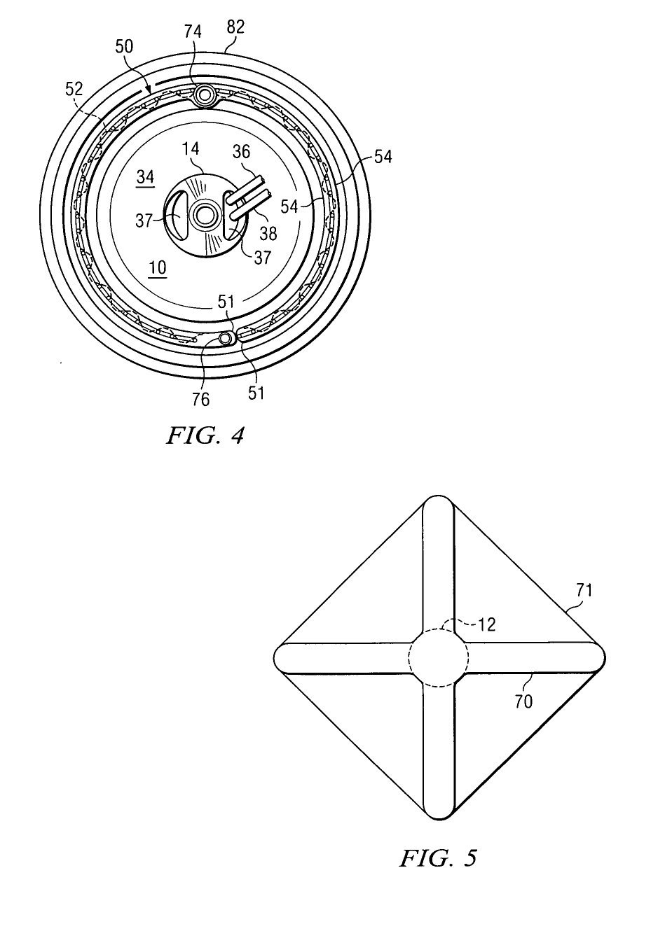

Referring to FIGS. 1-5, an apparatus 10 for repairing underground pipes includes an elongated rigid cylindrical support member or mandrel 12 preferably fabricated from a tube 13 made of plastic pipe such as polyethylene (PE), polyvinyl chloride (PVC), high density polyethylene (HDPE) or similar material. A centering cone or end cap 16 on the forward end of apparatus 10 forms a tapered nose and has a rearwardly extending cylindrical extension 19 that extends into mandrel 12 and is held there by screws inserted through the adjoining wall of tube 13. A rearwardly tapering, plastic rear end cap 14 is secured over the rear end of tube 13 in a manner similar to cap 16. End cap 14 has a threaded rear opening 20 for connecting mandrel 12 to matching external threads of a steel adapter 22, which in turn has a threaded socket 23 for connecting mandrel 12 to a drill string driven by an HDD or similar machine.

Apparatus 10 includes at least one generally cylindrical expander mounted on or fitted over mandrel 12. In the illustrated embodiment, the expanders include a inner tube-shaped front inflatable bladder 32, middle inflatable bladder 33 and inflatable rear bladder 34 positioned end to end and secured to mandrel 12 by a cover 35 that is fastened to mandrel 12 at opposite ends of the bladders 32-34 by a pair of hose clamps 40. Bladders 32-34 serve to expand the repair band against the inside of a pipe to be repaired and, to the extent needed, hold it in position during the repair to allow the grout to cure. Bladders 32-34 are generally cylindrical in shape when inflated, coaxial with mandrel 12, and are formed from a tough, durable material such as a urethane, nylon or other suitable synthetic material. In a completely deflated state, bladders 32-34 collapse from the positions shown in the drawings. In the alternative, if it is desired that bladders 32-34 maintain the shape shown in FIG. 1 without partial inflation, an open-celled plastic foam core can be provided inside of each bladder.

A pair of air hoses 36, 38 extend through a side opening 37 in cap 14 into mandrel 12. Hose 36 is secured at an outlet port 39 in tube 13 to supply compressed air or similar fluid into middle bladder 33. Hose 38 is split into two branches through further outlet ports 39 to supply compressed air for simultaneous inflation of front and rear bladders 32, 34. Hoses 36, 38 are individually controlled by valves back at the air compressor.

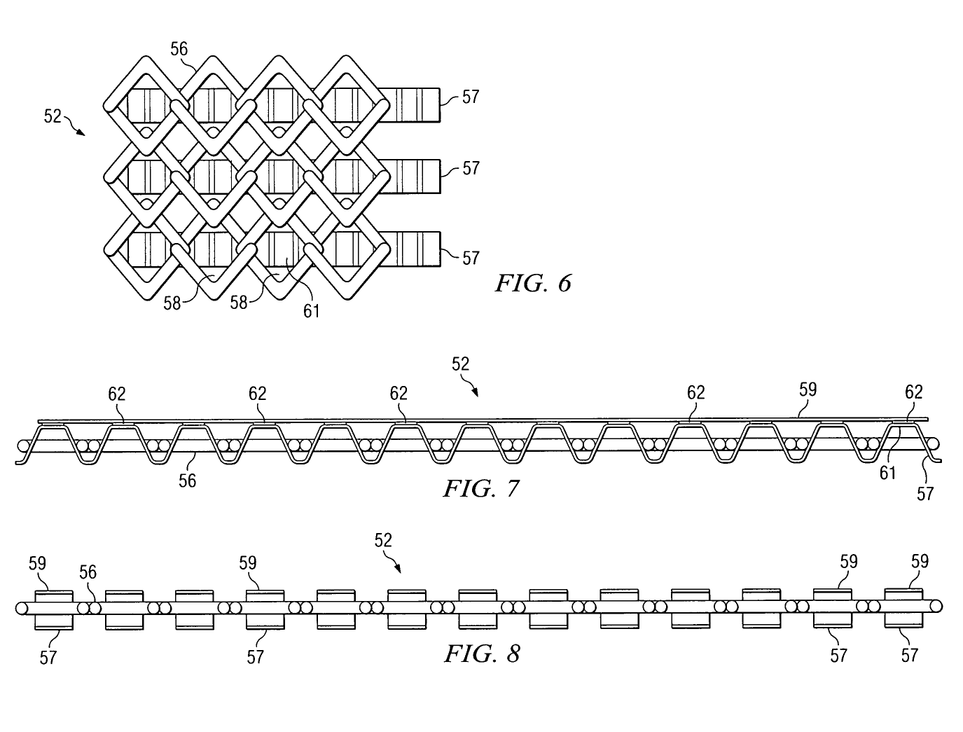

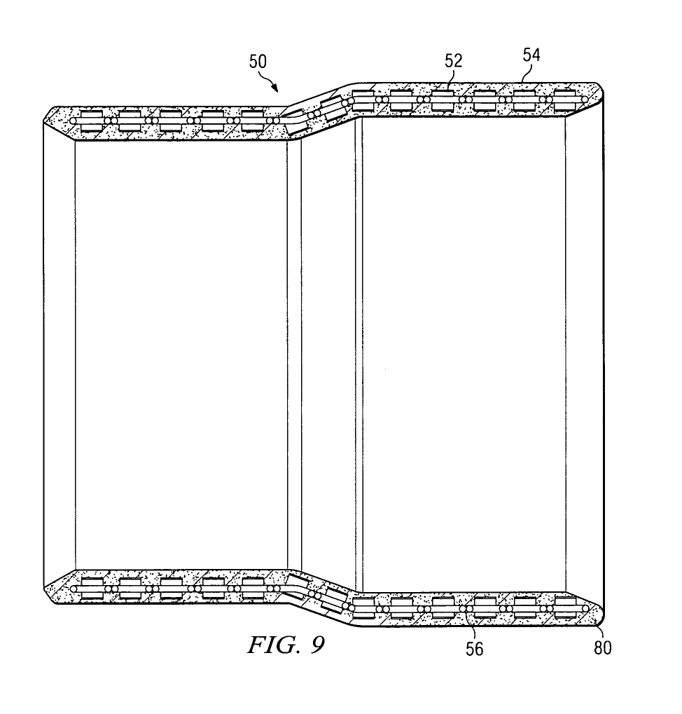

A repair band 50 for repairing a separated joint, crack or hole in a pipe or culvert is wrapped or folded around apparatus 10. As illustrated in FIGS. 1-4, repair band 50 comprises a resilient reinforcing frame 52 disposed inside a cylindrical cover 54. As shown in FIG. 6-8, frame 52 in a preferred form of the invention comprises a chain link sheet 56 having a series of corrugated steel strips 57 disposed in alternate rows of mesh openings 58 and covered on the opposite side by flat bands 59. Bands 59 are intermittently spot-welded to the tops of corrugations 61 at welds 62. A frame with the foregoing design has proven durable and strong for use in environments subject to vibrations, such as railroad beds. In less active sites, a single sheet of mesh or corrugated material may prove sufficient. Frame 52 is preferably permeable to the injected grout and permits the grout to spread out evenly through and on both sides of it.

Cover 54 comprises a pair of sheets 66 of nylon or similar fabric, such as commonly used as tarp or ground cover, that is impermeable to the grout. Sheets 66 are bonded around their edges with frame 52 between them, sealing frame 52 inside. The resulting band 50 is rectangular in its flat condition, and is bent into a cylinder with its ends 51 touching or overlapping prior to use. Suitable means such as a band 67 of shrink wrap, rope or the like is used to hold band 50 in its cylindrical shape, which is smaller than the internal diameter of the pipeline into which the band will be inserted. The extent to which the ends overlap is not great but will vary depending on the amount that the band 50 will expand when installed. It is possible, for example, to apply band 50 inside a culvert of square or rectangular rather than circular cross-section, but the extent of overlap will be greater. As an alternative to overlapping the ends, band 50 can be compressed into a partly folded shape 70 (FIG. 5), and then held in that shape by one or more bands of shrink wrap 71.

A grout inlet manifold 72 is inserted into one end of the band 50 by making a slit in the fabric at the desired entry location, about half way between the two ends. Inlet manifold 72 is a tube having a length slightly less than the width of band 50 and a series of sets of perforations 73 therein, preferably in spaced pairs that are alternately offset by ninety degrees so that grout flows out in four directions. A grout inlet tube 74 is attached to one end of manifold 72 and extends rearwardly therefrom far enough to extend beyond the edge of bladder 34. An air outlet tube 76 is mounted in a slit in the fabric of cover 54 near one end 51.

Prior to use, band 50 is placed over mandrel 12 and preferably at least middle bladder 33 is inflated to the extent necessary such that band 50 is securely mounted thereon with its ends overlapped. Band 50 is preferably positioned so that manifold 72 is at or near the top of band 50 and air outlet 76 is at the bottom. The HDD machine is then operated so that band 50 and mandrel 12 are positioned as shown in FIG. 1 near a break 81 in a conduit or culvert 82. Positioning may be by direct visual observation or with the use of a camera inserted into the pipe. If an HDD machine is not available, the assembly can be positioned by manual pushing with a rod from the near side, pulling with a winch-driven cable attached to mandrel 12 from the far side of the pipeline, or the like.

After apparatus 10 is positioned at the repair location, bladders 32-34 are inflated with compressed air fed through hoses 36, 28 so that band 50 expands (uncoils or unfolds), stretching or breaking wrap 67, into contact with the inner periphery of conduit 82. If the inner surface of the conduit is irregular or no longer completely coaxial, frame 52 is flexible enough to allow band 50 to conform to the actual contour at break 81. Front and rear bladders 32, 34 expand to a greater extent than middle bladder 33 and engage the inside of conduit 82 to anchor the assembly into position. However, an embodiment with only a single bladder 33 could be used in lieu of the three bladder arrangement shown. In such a case, the entire interior of tube 13 could act as the air conduit and it would be unnecessary to run air hoses inside of tube 13. Band 50 in expanded form preferably has its ends 51 either touching or only slightly overlapping. A space between ends 51 would normally be detrimental because it would create a gap through which water or the like could leak from the pipeline.

A flowable grout or cement such as fast-setting concrete 80 is pumped through a grout hose that is connected to grout inlet tube 74 which conducts the cement into manifold 72. The cement exits through holes 73 and flows evenly down both sides of frame 52, permeating frame 52. Displaced air from the inside of cover 54 exits through air outlet tube 76. Filling of band 50 with cement is complete when cement can be observed oozing or sputtering from outlet tube 76. At this time, pumping of the cement ceases and pressure from bladder 34 collapses the exposed end of manifold 72, forcing uncured cement out of it. Manifold 72 and tubes 74, 76 are preferably then removed and cleaned for re-use.

The thickness of band 50 when cover 54 is filled with grout is usually in the range of from about 1 to 3 inches, or as needed to fully embed frame 52 and create a casting of sufficient strength that does not excessively restrict the inner diameter of conduit 82. When a cement of heavy consistency is used as the grout, the thickness of frame 52 generally determines the thickness of band 50. For this purpose, frame 52 is pervious to the cement but has a laterial spacing element that gives frame 52 its thickness. In this example, corrugated strips or bent wires 57 perform this function. Frame 52 could also comprise a corrugated metal sheet with perforations through it, e.g. in staggered, spaced rows. A thin, essentially two-dimensional frame 52 is not preferred for use with cover 54 and a heavy cement as the grout because it is difficult to fill cover 54 with cement to a unform thickness without frame 52 providing the space for the cement to flow into.

The injected grout is allowed to cure until band 50 is self supporting and sufficiently strong so that curing can run to completion without the support of bladders 32-34. The time needed may vary from almost none to as much as about 2 or 3 hours, typically 30-60 minutes, especially depending on the cement used and the stress the band will be subjected to (as from trains passing on tracks above a culvert while the band in curing). Fast-curing cements tend to generate considerable heat and this must be taken into account in the design of the apparatus. After preliminary curing, bladders 32-34 are deflated and apparatus 10 is removed from pipe 81 by withdrawing the drill string, pulling on the cable, or the like. The described method does not require complete draining of the conduit or pipeline and can even be can even be carried out with a bottom portion of the repair band under water.

In an alternative embodiment of the foregoing method, cover 54 is omitted entirely or replaced with a sheet or membrane on the outside of frame 52. The grout is then injected through a tube like tube 74, or one which passes through the center of mandrel 12 and then radially out past or through bladder 33. Bladders 32-34 thereby form a space or mold in which the grout is confined. Use of a sheet or membrane outside of frame 52 is preferably to avoid leakage of grout through break 81 and into the surrounding soil. In this embodiment, it is more important to keep apparatus 10 in position with bladders 32-34 inflated until the grout has hardened enough to maintain its shape. Bladders 32-34 must also be made of a material that can release from the grout without sticking. For these reasons, this version of the method of the invention is less preferred than the one described previously.

According to another variation of the procedure, cover 54 is prefilled with grout prior to insertion into the pipeline, and then formed into its final shape rapidly before the grout hardens to too great an extent. This eliminates some of the difficulty of feeding the grout through long lines which must then be cleaned, but the pre-filled band 50 is much heavier and hence more difficult to put into position.

In some environments it may be feasible to omit frame 52 altogether and simply create the repair band from the cast grout alone. For this purpose cover 54 might be provided with stiffening ribs on the inside or outside. However, frame 52 reinforces and stabilizes the cured grout. As is well known, many cements including concrete based grouts have high compressive strength, but limited tensile strength. Frame 52 reinforces the cured cement by absorbing tensile stresses and loads that would otherwise crack or break the cement in the repaired area. Thus, the use of frame 52 ensures that the repair will survive subsequent loading and stresses due to movement of the earth around the pipe. Since band 50 in any of the preceding embodiments is flexible enough to be wrapped and/or folded onto apparatus 10 and expanded to conform to the inside surface of a pipe or culvert, the need for personnel to access the repair site is eliminated. This is particularly advantageous in the case of smaller diameter pipes that repair personnel cannot physically enter to manually position a repair band.

As the means for controlling radial expansion and contraction of the expander, a bladder provided with a line permitting inflation is the simplest method and is most preferred. However, a mechanical system provided with radial legs that push the stiffening frame could be used, such as one similar to the frame structure described in commonly-assigned Wentworth et al. U.S. patent application Ser. No. 11/324,018, filed Dec. 30, 2005, the contents of which are incorporated by reference herein. It is also possible to coil the repair band more tightly prior to inserting it into the pipeline, secure it with a cord, clip or the like, and then sever the cord once the band is in the proper position, whereby it uncoils in a forceful manner and becomes lodged against the inside of the existing pipeline. The “means” in such a case would be the cord or fastener in combination with the resilience of the stiffening frame.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

1. An apparatus for repairing an underground pipe, comprising
a mandrel having a first expander capable of extending and retracting in a radial direction;
means for causing radial expansion and retraction of the expander when in position at a pipe location in need of repair;
a resilient stiffening frame disposable in a tubular configuration outside of the expander, such that the expander can be used to expand the frame towards the inside of the pipe; and
means for confining a flowable cement between the expander and the inside of the pipe to form a repair band upon setting of the cement, wherein the stiffening frame is pervious to the cement and has a spacing element that defines a minimum thickness of the repair band.

2. The apparatus of claim 1, further comprising a supply line for introducing a stream of flowable cement between the expander and the inside of the pipe.

3. The apparatus of claim 1, wherein the expander comprises a central inflatable bladder, and the means for controlling radial extension and retraction of the expander comprises a line supplying pressurized air to the bladder.

4. The apparatus of claim 1, wherein the confining means comprises a cover for the stiffening frame, which cover is impervious to the cement.

5. The apparatus of claim 3, wherein the confining means comprises a pair of outer, second inflatable bladders disposed at opposite ends of the central bladder, the second expanders operable to form annular seals at opposite ends of the space for the repair band.

6. The apparatus of claim 1, wherein the spacing element comprises one or more corrugated strips.

7. The apparatus of claim 6, wherein the stiffening frame comprises a steel mesh sheet wherein projections of the corrugated strips extend through openings in the mesh sheet, and the stiffening frame is coiled about the mandrel so that its ends overlap.

8. The apparatus of claim 1, wherein the mandrel comprises a tube having a radial port therein and an air conduit inside the tube and opening at the port, and the expander comprises an inflatable bladder mounted on the tube, wherein the interior of the bladder is communication with the port whereby the bladder can be inflated and deflated through the air conduit.

9. The apparatus of claim 8, wherein the mandrel tube has one end portion configured for connection to a rod string.

10. The apparatus of claim 1, wherein the means for confining the cement comprises a fabric sleeve having the frame disposed inside, which sleeve is sealed except at a cement inlet opening connected to the cement supply line, and an outlet opening for air displaced by the cement., and wherein the fabric sleeve having the frame disposed inside is coiled about the mandrel so that its ends overlap.

11. A method for repairing a pipe, comprising:
positioning a flexible stiffening frame inside the pipe at a location to be repaired;
positioning an extendable expander inside of the frame;
extending the expander to push the frame radially outwardly towards the inside of the pipe;
injecting a flowable cement into a space between the expander and the inside of the pipe; and
confining the cement so that it forms a repair band having the frame embedded therein upon curing.

12. The method of claim 11, further comprising:
maintaining the expander extended until the cement cures sufficiently to be self-supporting; and
then retracting the expander.

13. The method of claim 1l, wherein the expander is mounted on a mandrel, and the positioning steps comprise wrapping the stiffening frame around the mandrel and expander, then inserting the mandrel and expander into the pipe and moving it to the location to be repaired.

14. The method of claim 13, wherein the inserting step comprises connecting one end of the mandrel to the end of a drill string and operating a directional drilling machine to extend the drill string to the location to be repaired.

15. The method of claim 13, further comprising securing the repair band around the mandrel temporarily with a wrapping that is stretched or broken when the expander extends.

16. The method of claim 11, wherein the expander comprises an inflatable bladder and the step of extending the expander comprises inflating the bladder with a pressurized fluid.

17. The method of claim 11, further comprising mixing the cement to a curable state and then pumping it through a supply line to the space between the expander and the inside of the pipe.

18. A pipeline joint, comprising:
a first pipe section;
a second pipe section adjacent the first section; and
a repair band disposed inside and spanning the first and second pipeline sections, the repair band comprising a resilient metal frame embedded in a hardened cement, the band having a length less than that of the pipeline sections, whereby one end of the repair band opens onto the interior of the first conduit section, and the other end of the repair band opens onto the interior of the second pipeline section.

19. The conduit joint of claim 18, wherein the first and second pipe sections are not coaxial, and the repair band contacts and conforms to the inner surfaces of the first and second pipeline sections.

20. The conduit joint of claim 18, wherein pipeline comprises an underground culvert, and the repair band seals a break in the pipeline at a juncture between the first and second sections.
